(19) United States
(12) Patent Application Publication
(10) Pub. No.: US 2007/0259258 A1
(43) Pub. Date: Nov. 8, 2007

(54) BATTERY ASSEMBLY WITH TEMPERATURE CONTROL DEVICE

(76) Inventor: Derrick Scott Buck, Pendleton, IN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/743,777

(22) Filed: May 3, 2007

Related U.S. Application Data
(60) Provisional application No. 60/797,539, filed on May 4, 2006.
(60) Provisional application No. 60/809,376, filed on May 30, 2006.

(51) Int. Cl. H01M 10/50; H01M 10/04

(52) U.S. Cl. 429/120; 429/159; 29/623.1; 180/65.3

(57) ABSTRACT

A battery assembly has a plurality of battery packs each presenting a housing and multiple cells adjacent one and the other and disposed in the housing. A foam solution is injected into the case of each battery pack. The foam extends around each cell and the case to encapsulate each cell thereby eliminating air gaps between the cells and the case and receiving heat generating by the cells in operational mode of the battery pack.

### RELATED APPLICATIONS

This non-provisional application claims priority to provisional application Ser. No. 60/797,539 filed on May 4, 2006 and 60/809,376 filed on May 30, 2006 and incorporated herewith by reference in its entirety.

### FIELD OF THE INVENTION

The subject invention relates to battery packs having cells and more particularly, to a battery pack for electric/hybrid vehicles having a cooling system for cooling of the cells within the battery pack.

### BACKGROUND OF THE INVENTION

Motor vehicles, such as, for example, hybrid vehicles use multiple propulsion systems to provide motive power. This most commonly refers to gasoline-electric hybrid vehicles, which use gasoline (petrol) to power internal-combustion engines (ICEs), and electric batteries to power electric motors. These hybrid vehicles recharge their batteries by capturing kinetic energy via regenerative braking. When cruising or idling, some of the output of the combustion engine is fed to a generator (merely the electric motor(s) running in generator mode), which produces electricity to charge the batteries. This contrasts with all-electric cars which use batteries charged by an external source such as the grid, or a range extending trailer. Nearly all hybrid vehicles still require gasoline as their sole fuel source though diesel and other fuels such as ethanol or plant based oils have also seen occasional use.

Batteries and cells are important energy storage devices well known in the art. The batteries and cells typically comprise electrodes and an ion conducting electrolyte positioned therebetween. The art is replete with various designs of battery cell modules having retention devices are disclosed in numerous prior art references both foreign and domestic.

The U.S. Pat. Nos. 4,053,691 to Ciliberti, Jr., for example, teaches a battery pack having a case, a pair of cells stacked one on top of the other and disposed in the case. A multitude of beads fills the space defined between the case and the cells. The beads are fused by an adhesive and define air gaps therebetween. The case includes vents which are used to release gas generated by the cells. Gas passes freely through the voids and around the beads to safely venting the battery pack. This design reduces the structural integrity of the battery pack and leaves air gaps between the case, which keeps heat inside the case thereby reducing product life or promoting premature failures of the battery pack.

The Japanese Application No. 2003049459 to Naoki et al. teaches a battery pack having a case and a cell envelope disposed in the case. A heat absorption layer is disposed between the cell envelope and the case. The heat absorption layer is designed to absorb heat generated by the cell envelope. The design disclosed by the Japanese Application No. 2003049459 to Naoki et al. does not transfer heat beyond the case of the battery pack and keeps heat inside the case thereby reducing life span of the battery pack.

The U.S. Pat. No. 4,418,127 to Shambaugh et al. teaches a battery cell module having a case including a cover, spacers, and cells disposed in the case. Before foam is applied all the surfaces must be “finished” for achieving a good bond between the materials by roughing the surfaces of the aforementioned parts to be bonded and insuring that they are thoroughly cleaned and free of any oil or other surface contaminants. After the foam has hardened, the cover is bonded over the exposed foam to form the top side of the case. The injection of the foam requires either chemically etching or sand blasting the aforementioned parts and degreasing the parts in a vapor degreaser, which is time consuming, labor intensive, and requires additional steps and materials to be used before injecting the foam. Furthermore, the U.S. Pat. No. 4,418,127 to Shambaugh et al. teaches that the cover has to be placed after the foam is hardened, thereby leaving potential air gaps which leads to a clearance defined between the foam and the cover.

The Japanese Patent Application No. JP2002373708 assigned to Hitachi Koki teaches a battery pack having a plurality of cylindrical cells disposed therein and a heat receiving part of a flat heat pipe connected to the cells and is thermally coupled to a heat radiating fin mounted on the outside of a battery case. The fin does not present direct contact with the cells thereby reducing heat isolating characteristics of the battery pack taught by the Japanese Patent Application No. JP2002373708.

As such, there is a constant need in the area of the battery art for an improved design of a battery pack having effective packaging characteristics, structural integrity thereby eliminating problems associated with current designs of prior art battery packs.

### SUMMARY OF THE INVENTION

A battery assembly of the present invention is adaptable to be utilized in various configurations including and not limited to an overlapping battery cell packaging configuration and a vertical stack battery cell packaging configuration used in an automotive vehicle. The battery assembly has a plurality of battery packs each presenting a case and multiple cell adjacent one and the other and disposed in the case. Each cell has a first current collector and a first electrode adjacent the first current collector and a second current collector and a second electrode of charge opposite from the first electrode and adjacent the second current collector. A separator layer is positioned between the first and second electrodes with the first and second electrodes conducting electrolyte therebetween. A foam solution is injected into the case of each battery pack. The foam extends around the perimeter of each cell's sealed edges and the case to encapsulate each cell thereby eliminating air gaps between the cells and the case.

In another aspect of the present invention, a plurality of fins are formed from a heat absorption material and are disposed between the cells and extend through and beyond the case for absorbing heat generated by the cells and transferring heat beyond the case thereby maintaining a lower temperature inside each battery pack and the battery assembly. A foam solution is injected into the case of each battery pack. The foam extends around the perimeter of each cell's sealed edges and the fins and the case to encapsulate each cell thereby eliminating air gaps between the cells, the fins, and the case. A fan of the battery assembly is adjacent the battery packs. The fan introduces conditioned air into the fins extending through and beyond the case thereby cooling the fins and removing heat away from the battery packs.

An advantage of the present invention is to provide a battery assembly having efficient packaging characteristics which provides excellent retention that surrounds and secures cells, and consequently secures the internal electrode stack within the cell.

The retention method also provides the necessary flexibility for expansion and contraction of soft cells during the charge and discharge cycles.

Another advantage of the present invention is to provide a cost effective, low mass design of a battery pack which includes polyurethane foam as a retention device verses that of traditional methods of retention, such as, for example, silicone adhesives.

Still another advantage of the present invention is to provide a battery pack having a chemical resistant design wherein the internal components of the battery pack are encapsulated by the polyurethane foam which greatly reduces the potential permeation of liquids into the battery pack, or leakage from inside the battery pack to the outside of the battery pack thereby preventing reduced product life or premature failures of the battery pack.

Still another advantage of the present invention is to provide a battery pack design with improved heat absorption characteristics wherein insulating air gaps are eliminated which promotes the absorption of heat generated inside the pack to be transferred to the outside of the pack.

Still another advantage of the present invention is to provide a battery pack that reduces manufacturing costs due to simplified assembly pattern.

Still another advantage of the present invention is to provide a battery pack having a balanced air management cooling system wherein each cell of the battery pack receives a similar temperature and flow of inlet air to assist removing the undesired heat.

Still another advantage of the present invention is to provide a cooling system which allows the battery pack to deliver and receive high and fast rates of current, i.e. the C-rate, without producing heat during the rapid charge or discharge pulse that may negatively impact the performance and life span of the battery pack.

Still another advantage of the present invention is to provide a pack that is simple in design and has a reduced weight.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a plurality of cells interconnected with one another and partially encapsulated by a foam to form a pack;

FIG. 2 shows alternative embodiment of the pack of FIG. 1 having extensions integral with the foam encapsulating the pack for connecting the pack to a surface such as a body of a vehicle (not shown);

FIG. 3 is a cross sectional view of a mold device of the inventive method for injecting the foam into the mold device to at least partially encapsulate the cells in the mold device;

FIG. 4 is a perspective view of still another alternative embodiment of the pack having a housing (only one half is shown) having a plurality of the cells disposed in the housing and the foam injected to fill voids defined between the cells and the housing, the cells being partially encapsulated wherein the cells are connected to the electrical bus assembly;

FIG. 5 is a perspective and cross sectional view still another embodiment of the present invention showing a plurality of fins disposed between the cells and extending through the housing for removing heat from inside the battery pack; and

FIG. 6 shows a top view of a plurality of battery packs of FIG. 6 adjacent one another and a fan injecting cool fluid into the fins to remove heat away from the battery packs.

### DETAILED DESCRIPTION OF THE PREFERRED EMBODIMENT

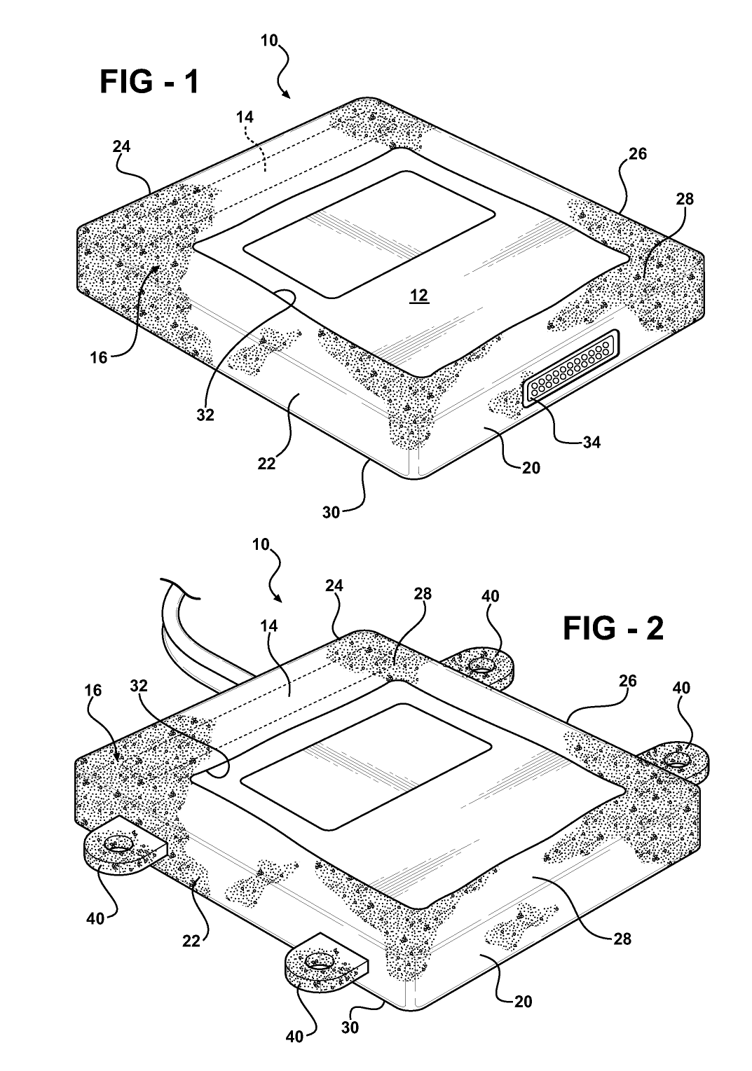

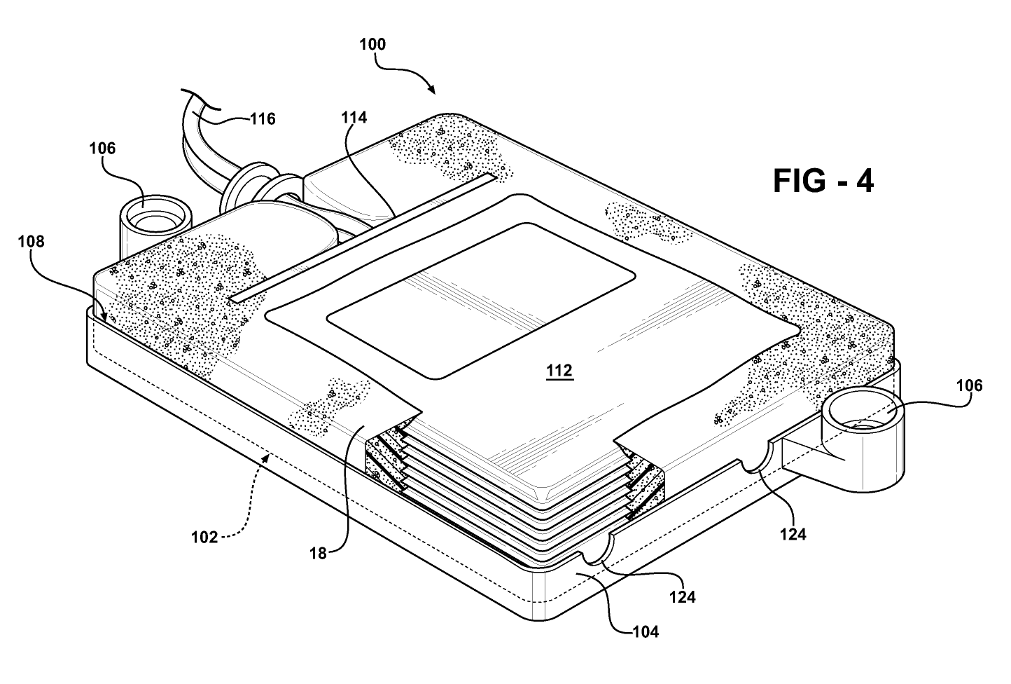

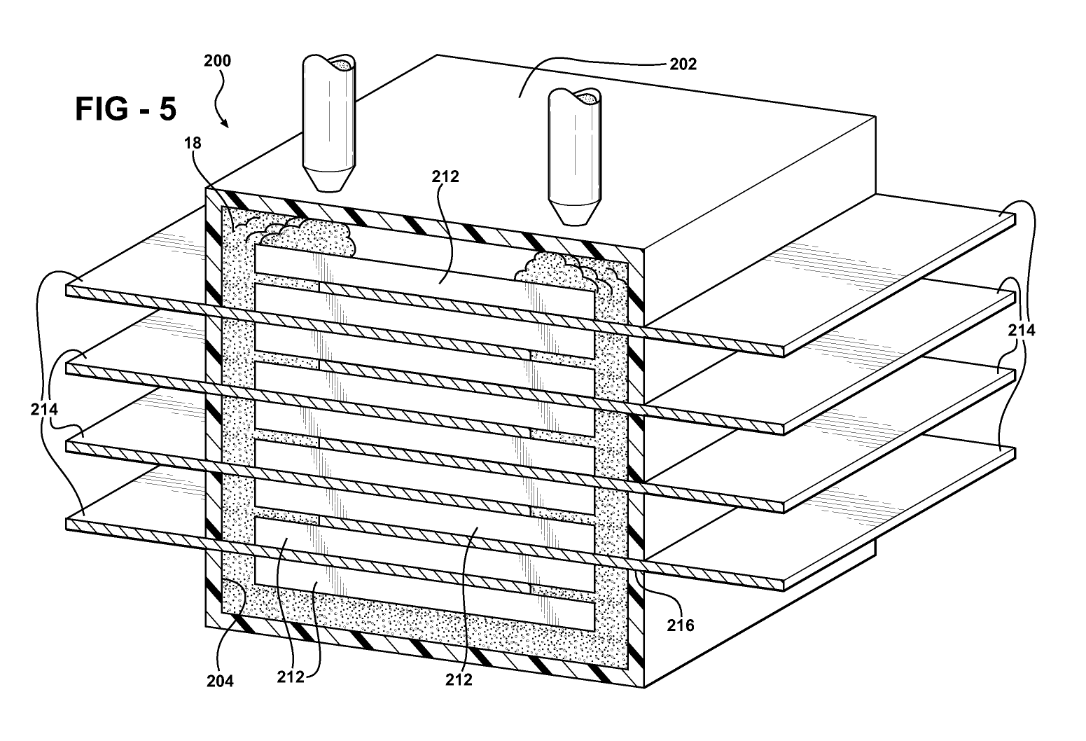

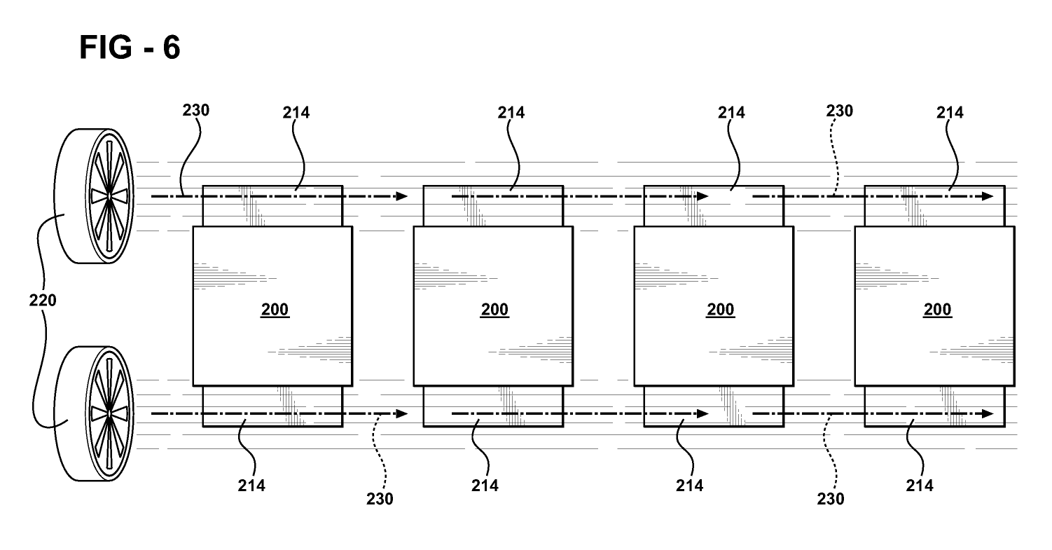

Referring to the Figures, wherein like numerals indicate like or corresponding parts, a battery pack or unit assembly (the assembly) of the present invention is generally shown at 10 in FIGS. 1 through 3. A first alternative embodiment of the present invention is generally shown at 100 in FIG. 4. A second alternative embodiment of the present invention is generally shown at 200 in FIGS. 5 and 6. The assemblies 10, 100, and 200 of the present invention are adaptable to be utilized in various configurations including and not limited to an overlapping battery cell packaging configuration and a vertical stack battery cell packaging configuration used in an automotive vehicle applications. Various cells are utilized with the present inventive concept. Preferably, lithium cells (the cells or cell) 12, 112, 212 are used with the present invention.

Alluding to the above, the assemblies 10, 100, and 200 of the present invention includes a lithium electronic controller (the LEC), shown in phantom at 14 in FIGS. 1 and 2, and 114 in FIG. 4, are connected to each of the respective cells 12 and 112 and operably communicates with each of the cells 12, 112. Those skilled in the battery art will appreciate that the high voltage battery units deliver and receive high and/or fast rates of current (C-rate). The problem is that in exchange for the high C-rate capability, the battery units produce heat during this rapid charge or discharge pulse.

As illustrated in FIGS. 1 and 2, the assembly 10 includes a case, generally indicated at 16, formed from a foam 18. The case 16 may be formed from a non-polymeric material. The case 16 presents side edges 20 through 26 and a pair of opposite sides 28 and 30, with one of the sides 28 being partially exposed, as shown in FIGS. 1 and 2, to define a fame 32, without limiting the scope of the present invention. Alternatively, the case 16 completely encapsulates the cells 12. The frame 32 is used to identify the type of the cells 12 and to reduce the weight of the assembly 10. In one embodiment, the assembly 10 includes a connector port 34 incorporated in the case 16 for connecting the case into a terminal (not shown) for powering the application. FIG. 1 does not illustrate assembly 10 mounting features for surface attachment, such as the body of the vehicle (not shown).

Alternatively, as shown in FIG. 2, a plurality boss sections or extension members 40 are formed in at least two side edges 22 and 26 for connecting the assembly 10 to the surface and designed to receive respective fasteners (not shown) extending from the surface to secure the assembly 10 thereto. The boss sections 40 may be formed from another material to provide without limiting the scope of the present invention.

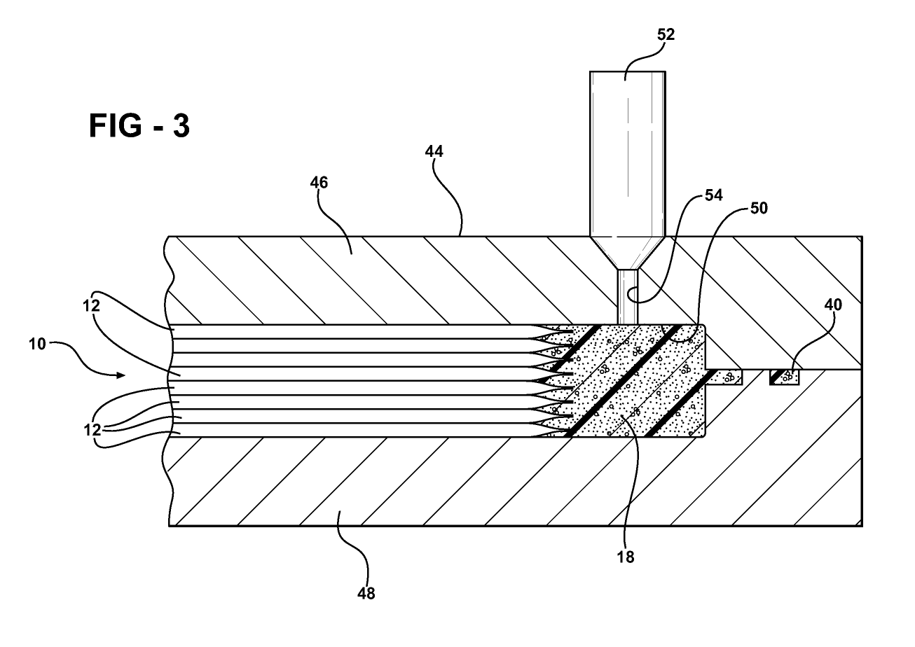

As illustrated in FIG. 3 as the assembly 10 is formed, the individual cells 12 are connected to electric components, and placed in to a mold device 44 having a first mold 46 and a second mold 48 defining a cavity 50, wherein the cells 12 are placed. The polyurethane foam solution (the foam 18) is injected through a nozzle 52 into the cavity 50 to secure the cells 12 and associated electrical components (not shown) within the assembly 10. The mold device 44 is adjusted to increase the width and the heights of the assembly 10 to be formed. The mold presents a closure having at least one opening to inject the foam 18. The mold device 44 may include a multitude of cavities (not shown) to form as many assemblies 10 as required by manufacturer.

Alluding to the above, the foam 18 is injected into the mold device 44 through openings 54 defined therein. A delayed chemical reaction between the two parts of the urethane that creates an out-gassing of carbon dioxide that causes the mix to expand as a “closed cell foam”, and thus filling any voids formed between the cells 12. The abundance of surface area contact and excellent adhesion properties of the foam 18 to the internal components provides a significant mechanical advantage of retention verses traditional methods such as RTV. The expansion of the foam 18 also greatly enhances the structural integrity of the assembly 10 with respect to shock, vibration, and crush loads. Heat transfer coefficients are improved due to the elimination of associated insulation layers created by dead air gaps. The foam 18 is a two-part polyurethane, available in densities down to less that 1 lb/ft³. The foam 18 occupies less than 5% of the entire pack volume inside the case 16. The foam 18 may also occupy more than 5% of the entire pack volume inside the case 16 without limiting the scope of the present invention.

Referring to FIG. 4, the assembly 100 includes a housing generally indicated at 102 having a pair of halves, only one is shown at 104. A pair of extensions 106 may extend from the housing 102 for connecting the housing to the surface 36. The housing 102 defines an internal pocket portion, generally indicated at 108 to receive the cells 112 and electronic control components 116 connected thereto. The housing 102 is fabricated from a polymeric material. Alternatively, the housing 102 is formed from a non-polymeric material without limiting the scope of the present invention. As the assembly 100 is formed, the individual cells 112 connected to the electric components 116 are placed in to the pocket 108. The foam 18 is used to secure the cells 112 and associated electrical components 116 within the housing 102.

Preferably, the housing 102 includes opening (not shown) to receive the laminar flow of a mixed two-part polyurethane poured into the pocket portion 106 after the cells 112 and the electrical components 116 and the like, are placed into the assembled housing 102. A delayed chemical reaction between the two parts creates an out-gassing of carbon dioxide that causes the mix to expand as a “closed cell foam”, and thus filling any voids formed between the cells 112, and the housing 102. The abundance of surface area contact and excellent adhesion properties of the foam 18 to the internal components provides a significant mechanical advantage of retention verses traditional methods such as RTV. The expansion of the foam 18 also greatly enhances the structural integrity of the assembly 100 with respect to shock, vibration, and crush loads. Heat transfer coefficients are improved due to the elimination of associated insulation layers created by dead air gaps.

Referring to the FIGS. 5, the assembly 200 of the present invention a case 202 defining a pocket portion 204 to receive the cells 212 and electronic control components (not shown) connected thereto. The case 202 is fabricated from a polymeric material and includes a plurality of retention devices (not shown) integral with the case 202 and designed to receive respective fasteners (not shown) extending from a body of a vehicle to secure the assembly 200 thereto. The case 202 may be formed from a non-polymeric material. As the assembly 202 is formed, the individual cells 212 are connected to the electronic control components and placed in to the pocket 204.

A plurality of fins 214, formed from a heat absorption material such as aluminum or the like is disposed between each cell 212. The fins 214 extend through slits 216 defined in the case 202. The fins 214 extend beyond the case 202. In addition, the fins 214, formed from the heat absorption material, such as aluminum and the like, absorb heat generated by the cells 212 and transfers heat out from the case 202 of the assembly 200. The fins 214 are sandwiched between each cell 212 and extend beyond the case 202 thereby receiving heat from the cells 212 and sinking heat away from the case 202. Alternatively, the fins 214 are sandwiched between the cells 212 and extend beyond the case 202 in alternating fashion, as shown in FIG. 5.

Alluding to the above, the case 202 is molded over the cells 212 and the fins 214 disposed between the cells 212 to form the assembly 200. The case 202 may include at least one boss section or extension (not shown) integral with and extending from the sides of the case 202 to the pocket portion 204. The boss is designed to apply pressure to the cells 212 thereby limiting clearance between the cells 212 and the fins 214 disposed between the cells 214. The foam 18 is used to secure the cells 212 and associated electrical components within the assembly 200. The foam 18 is injected into the case 202 through openings (not shown) defined therein. Preferably, the openings are defined on side edges of the case 202. A laminar flow of a mixed two-part polyurethane may be poured into the assembly 200 after the insertion of the internal components, cells 212, the fins 214 and the like, into the case 202.

Referring to FIG. 6, a fan assembly 220 is adjacent several assemblies 200. The fan assembly 220 is designed to introduce conditioned air 230 into the fins 214 of each assembly 200 extending through and beyond the respective cases 202 and for cooling the fins 214 and removing heat away from the fins 214 and the assemblies 200. The inventive concept of the present invention provides other advantages over the prior art. One of the advantages of the present invention is to provide the assembly 10, 100, 200 having efficient packaging characteristics which provides excellent retention that surrounds and secures the cells 12, 112, 212, secures the internal electrode stack inside the cell, circuit board assemblies, and associated electronic components regardless of their form factors in addition to component irregularities or packaging techniques.

Second advantage of the present invention is unique design of the assembly 10, 100, 200 having improved adhesion and surface area contact between battery cells 12, 112, 212 and the foam 18 disposed therebetween and material density thereby providing the assembly 10, 100, 200 with the structural integrity being superior to prior art battery packs using traditional retention methods. Still another advantage of the present invention is to provide the assembly 10, 100, 200 having a chemical resistant design wherein the internal components of the assembly 10, 100, 200 are encapsulated by the polyurethane foam which greatly reduces the potential permeation of liquids into the assembly 10, 100, 200, or leakage from inside the assembly 10, 100, 200 to the outside of the assembly 10, 100, 200 thereby preventing reduced product life or premature failures of the assembly 10, 100, 200.

Alluding to the above another advantages of the present invention are shown. The inventive battery pack design presents improved heat absorption characteristics wherein the foam retention eliminates air gaps formed between the battery cells, which promotes the absorption of heat generated inside the pack to be transferred to the outside of the assembly 10, 100, 200. Still another advantage of the present invention is to provide the assembly 10, 100, 200 that reduces manufacturing costs due to simplified assembly pattern.

Another advantages of the present invention is to provide the assembly 10, 100, 200 having efficient packaging characteristics which provides excellent retention that surrounds and secures the cells 12, 112, 212, the internal electrode stacks within the cells 12, 112, 212, circuit board assemblies, and associated electronic components regardless of their form factors in addition to component irregularities or packaging techniques. This retention method also provides the necessary flexibility for soft cell expansion/contraction. Still another advantage of the present invention is unique design of the assembly 10, 100, 200 having improved adhesion and surface area contact between battery cells 12, 112, 212 and the foam 18 disposed therebetween and material density thereby providing the assembly 10, 100, 200 with the structural integrity being superior to prior art battery packs using traditional retention methods.

Still another advantage of the present invention is to provide the assembly 10, 100, 200 having a chemical resistant design wherein the internal components of the assembly 10, 100, 200 are encapsulated by the polyurethane foam which greatly reduces the potential permeation of liquids into the assembly 10, 100, 200, or leakage from inside the assembly 10, 100, 200 to the outside of the assembly 10, 100, 200 thereby preventing reduced product life or premature failures of the assembly 10, 100, 200.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A battery pack assembly comprising;
a housing presenting an enclosure,
a plurality of cells disposed in said enclosure,
a plurality of fins from a heat absorbing material sandwiched between said cell and extending beyond said housing for receiving heat from said cells and sinking heat away from said housing, and
a foam injected between said housing and said cells and surrounding said cells and said fins with said foam fusibly interconnecting said cells with said housing and compressing said cell relative to one another.

2. A battery pack assembly as set forth in claim 1 wherein said housing includes side walls and terminals ends with said housing being molded from a polymeric material.

3. A battery pack assembly as set forth in claim 2 wherein each of said cells is a lithium cell having a prismatic configuration.

4. A battery pack assembly as set forth in claim 3 wherein each of said fins is sandwiched between each of said cells and extends beyond said side walls thereby receiving heat from said cells and sinking heat away from said housing.

5. A battery pack assembly as set forth in claim 3 wherein each of said fins is sandwiched between each of said cells and extending beyond said housing in alternating fashion thereby receiving heat from said cells and sinking heat away from said housing.

6. A battery pack assembly as set forth in claim 3 wherein each of said fins is formed from a thermally conductive material.

7. A battery pack assembly as set forth in claim 1 wherein said foam is a two-part polyurethane and a closed cell foam.

8. A battery pack assembly as set forth in claim 1 wherein said foam is a low density foam, said low density being at least equal to or greater than 0.5 lb/ft³.

9. A battery pack assembly as set forth in claim 1 wherein said foam occupies less than 5% of the internal volume of said housing.

10. A battery pack assembly as set forth in claim 1 wherein said cells disposed in said housing include an electronic controller operably communicating with said cells and a connector connected with said controller and said cells and extending beyond said housing.

11. A battery pack assembly as set forth in claim 1 wherein said housing includes at least one member extending from said housing for connecting said housing to a surface.

12. A method of forming a battery pack, said method comprising the steps of:
forming a housing;
placing a plurality of cells disposed into the housing;
sandwiching a plurality of fins formed from a thermally conductive material between the cells and extending the fins through and outwardly from the housing to receive heat from the cells and sink heat away from the housing; and
injecting a foam to surround the cells and the housing and the fins to fusibly interconnect the cells with the housing and to compress the cells relative to one another.

13. A method as set forth in claim 12 wherein the step of sandwiching the fins is further defined by sandwiching the fins between each of the cells and extending beyond the housing to absorb heat from the cells and sink heat away from the housing.

14. A method as set forth in claim 12 wherein the step of sandwiching the fins is further defined by sandwiching the fins between each of the cells in alternating fashion and extending beyond the housing to receive heat from the cells and sink heat away from the housing.

15. A method as set forth in claim 12 including the step of forming the fins from a thermally conductive material.

16. A method as set forth in claim 12 wherein the step of injecting the foam between the cells is further defined by injecting the two-part polyurethane and a closed cell foam.

17. A method as set forth in claim 12 wherein the step of injecting the foam between the cells is further defined by injecting a low density foam.

18. A method as set forth in claim 12 wherein the step of injecting the foam between the cells is further defined by injecting the foam to occupy less than 5% of the internal volume of said housing.

19. A method as set forth in claim 12 including the step of connecting an electronic controller to the cells.

20. A method as set forth in claim 12 including the step of forming at least on member extending from the housing to connect the housing to a surface.

21. A vehicle having a battery pack assembly, said vehicle comprising:
a plurality of cells connected with one another, and
a housing formed from a foam injected at least partially between said cells and encapsulating said cell for receiving heat from said cells and sinking heat away from said housing, said housing presenting sides and peripheral ends and at least one member integral with and extending from at least one of said sides and peripheral ends for connecting said housing to said vehicle.

22. A vehicle as set forth in claim 21 wherein each of said cells is a lithium cell having a prismatic configuration.

23. A vehicle as set forth in claim 21 wherein said foam is a two-part polyurethane and a closed cell foam.

24. A vehicle as set forth in claim 21 wherein said foam is a low density foam, said low density being at least equal to or greater than 0.5 lb/ft³.

25. A vehicle as set forth in claim 21 wherein said cells disposed in said housing includes an electronic controller operably communicating with said cells and a connector connected with said controller and said cells and extending beyond said housing.

26. A vehicle as set forth in claim 21 including at least two of said housings.

27. A vehicle as set forth in claim 26 including at least one fan adjacent said housings for forcing fluid into each of said housings for removing heat from said housings.

28. A method of forming a battery pack assembly comprising the steps of:
placing a plurality of cells connected with one another into a mold having a cavity;
injecting a foam into the cavity to form a housing as the foam extends at least partially between the cells and encapsulates the cell to receive heat from the cells and to sink heat away from the housing; and
forming sides and peripheral ends of the housing and at least one member integral with and extending from at least one of the sides and peripheral ends;
removing the housing from the mold.

29. A battery pack assembly for comprising;
at least one housing presenting sides and terminal ends; wherein said housing includes at least one member extending from said housing for connecting said housing to a surface,
a plurality of lithium cells disposed in said housing, each said cell having at least one first electrode and at least one second electrode of charge opposite from the first electrode and a separator positioned between the first and second electrodes for conducting electrolyte therebetween,
a controller operably communicating with each of said cells and disposed inside said housing,
a plurality of fins formed from a heat absorbing material being sandwiched between said cell and extending beyond said housing for receiving heat from said cells and sinking heat away from said housing,
a foam injected between said cells and said housing and said fins with said foam fusibly interconnecting said cells with said housing and compressing said cell relative to one another, and
at least one fan adjacent said at least one housings for forcing fluid into each of said at least one housing for removing heat from said at least one housing.
